(19) United States
(12) Patent Application Publication
(10) Pub. No.: US 2010/0081009 A1
(43) Pub. Date: Apr. 1, 2010

(54) Spray Application of Liquid Precursors for CMAS Resistant Coatings

(75) Inventors: Warren Arthur Nelson, Clifton Park, NY (US); David Vincent Bucci, Simpsonvile, SC (US); David Forrest Dye, Cincinnati, OH (US); Anthony W. Reynolds, Burlington, KY (US)

Correspondence Address: GE Energy-Global Patent Operation;Fletcher Yoder PC, P.O. Box 692289, Houston, TX, 77269-2289, US

(73) Assignee: General Electric Company, Schenectady, NY (US)

(21) Appl. No.: 12/239,629

(22) Filed: Sep. 26, 2008

(51) Int. Cl. C23C 4/10; C23C 4/18; B32B 9/00; B05C 5/00

(52) U.S. Cl. 428/701; 427/331; 427/337; 427/372.2; 427/314; 118/300

(57) ABSTRACT

Methods and systems of applying a liquid precursor for a calcium-magnesium-aluminosilicate (CMAS) resistant coating to a turbine engine component are provided. In one embodiment, a method of manufacturing a turbine engine includes spraying a liquid compound, wherein the liquid component is stored with a carrier gas, applying the compound to a component of a turbine engine, such that the compound is disposed on a thermal barrier coating of the component, and forming an oxide layer on the thermal barrier coating of the component. In another embodiment, a system includes a turbine engine component and a sprayer containing a compound and a carrier gas, wherein the sprayer is configured to apply the compound to a thermal barrier coating of the component such that the compound forms an oxide on the thermal barrier coating.

### BACKGROUND

The invention relates generally to combustion engines such as gas turbine engines. More specifically, the disclosed embodiments of the invention relate to protective coatings for turbine components exposed to high temperatures.

Gas turbine engines include various components that are exposed to high temperatures during operation. Such components are often protected by a thermal barrier coating (TBC) that effectively insulates the components from heat, reducing the temperature of the components and extending the service life. Some of the TBC's used may be formed from ceramics and may have varying degrees of porosity.

The TBC formed on a component is itself susceptible to degradation by various processes that occur during operation of the turbine engine. One such degradation process that may occur is the formation of calcium-magnesium-aluminosilicate (CMAS) from engine dirt or other particles in the turbine engine. At the high operating temperatures of the turbine, built-up CMAS on engine parts may melt and penetrate pores in the TBC. As it solidifies, the CMAS may form stresses within the TBC, degrading the coating and causing increased temperature and wear of the turbine engine components. Additionally, other chemical process may occur as an indirect result of CMAS build-up, further degrading the TBC and damaging components of the engine. A CMAS-resistant coating may be applied through chemical vapor deposition (CVD) or dipping. However, such processes are expensive, unwieldy, and unsuitable for larger components of a turbine engine.

### BRIEF DESCRIPTION

In one embodiment, a method of manufacturing is provided that includes outputting liquid compound and applying the compound to a component of a turbine engine, such that the liquid compound is disposed on a thermal barrier coating of the component, and forming an oxide layer on the thermal barrier coating of the component.

In another embodiment, a manufacturing system is provided that includes a sprayer containing a liquid compound and a carrier gas, wherein the sprayer is configured to apply the liquid compound to a thermal barrier coating of the component, such that the liquid compound forms an oxide on the thermal barrier coating. The carrier gas may be an inert gas, such as nitrogen or argon, to prevent the liquid compound from reacting with water vapor existing in atmospheric conditions.

In another embodiment, a system is provided that includes a thermal barrier coating comprising yttria-stabilized zirconia and a protective coating of an aluminum oxide disposed on the thermal barrier coating, wherein the protective coating is a spray coating that oxidized in air.

In another embodiment, a system is provided that includes a machine subject to temperatures greater than about 1700° F., a thermal barrier layer disposed on a surface of a component of the machine, and a protective oxide layer disposed on the thermal barrier layer, wherein the protective oxide layer is a spray coating that oxidized in air.

### DRAWINGS

These and other features, aspects, and advantages of the present invention will become better understood when the following detailed description is read with reference to the accompanying drawings in which like characters represent like parts throughout the drawings, wherein:

FIG. 1 is a block diagram of an exemplary system having a gas turbine engine in accordance with certain embodiments of the present technique;

FIG. 2 depicts application and formation of a CMAS-resistant coating in accordance with an embodiment of the present invention;

FIG. 3 is a cross-section of a turbine engine component having a CMAS-resistant coating applied in accordance with an embodiment of the present invention; and

FIG. 4 is a flowchart illustrating a process for application and formation of a CMAS-resistant coating in accordance with an embodiment of the present invention.

### DETAILED DESCRIPTION

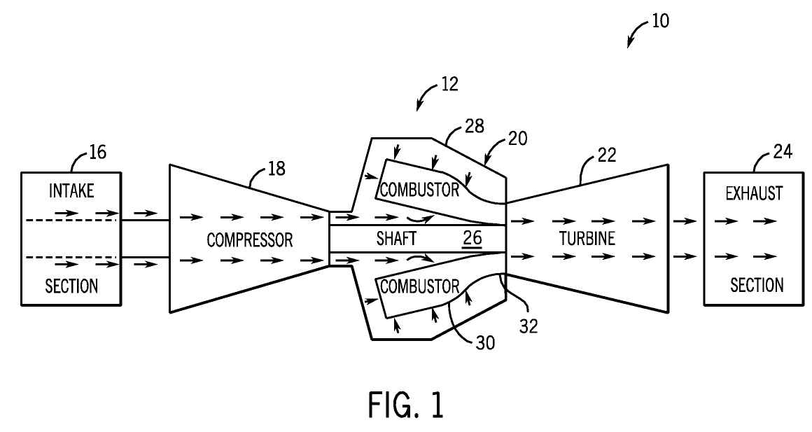

FIG. 1 is a block diagram of an exemplary system 10 including a gas turbine engine 12 in accordance with certain embodiments of the present technique. As discussed below, one or more components of the system 10 includes a CMAS-resistant coating applied, spraying of a precursor, air drying, and repetitions of these steps, rather than more costly and unsuitable CVD and dipping techniques. In certain embodiments, the system 10 may include an aircraft, a watercraft, a locomotive, a power generation system, or combinations thereof. The illustrated gas turbine engine 12 includes an air intake section 16, a compressor 18, a combustor section 20, a turbine 22, and an exhaust section 24. The turbine 22 is drivingly coupled to the compressor 18 via a shaft 26.

As indicated by the arrows, air flows through the intake section 16 and into the compressor 18, which compresses the air prior to entry into the combustor section 20. The illustrated combustor section 20 includes a combustor housing 28 disposed concentrically or annularly about the shaft 26 between the compressor 18 and the turbine 22. As discussed in further detail below, the compressed air from the compressor 18 enters each of the combustors 30, and then mixes and combusts with fuel within the respective combustors 30 to drive the turbine 22.

In certain embodiments, the combustors 30 may be configured as multi-stage combustors, wherein fuel injectors are positioned at different stages along the length of respective combustors 30. Alternatively, the combustors 30 may be configured as single stage combustors, wherein fuel injectors are arranged for a single stage or zone of combustion. In the following discussion, the combustors 30 are described as single stage combustors, yet the disclosed embodiments may be utilized with either single stage or multi-stage combustors within the scope of the present techniques.

The hot products of combustion pass through nozzles 32 leading to the turbine 22. These hot products of combustion drive the turbine 22, thereby driving the compressor 18 via the shaft 26. The hot products of combustion then exhaust through the exhaust section 24. As can be appreciated from the foregoing discussion, various components are exposed to the hot products of combustion that make their way through the turbine 22. For example, the nozzles 32 are exposed to the hot combustion gases, as well as combustor 20 or hardware of the turbine 22 (which may include any number of turbine blades). In some embodiments, the operating of turbine 22 may create internal temperatures of at least 1700° F. or higher. All the components of the gas turbine engine 12 within the hot gas path are susceptible to the build up of CMAS on the TBC of the components. Various CMAS-resistant coatings can be applied to prevent the build-up of CMAS. Embodiments of the present invention are directed to techniques for applying a CMAS-resistant protective coating that may be better suited for the larger components of the turbine engine 12 such as nozzles 32, walls of the combusters 30, blades of the turbine 22, etc. A dipping technique is not well-suited for large components or components having internal cavities, whereas the disclosed embodiments are well suited for both large components and components with internal cavities. Furthermore, the disclosed embodiments are simpler and less expensive than a typical CVD processes.

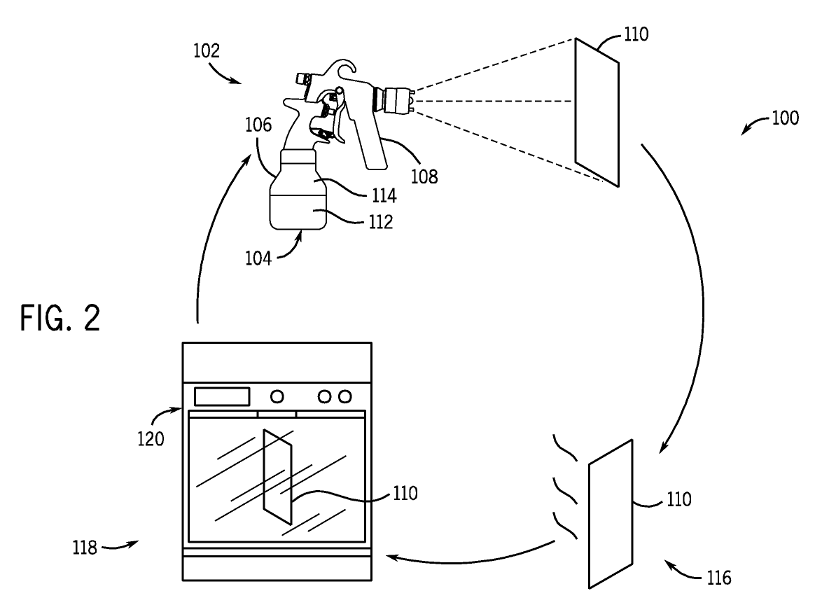

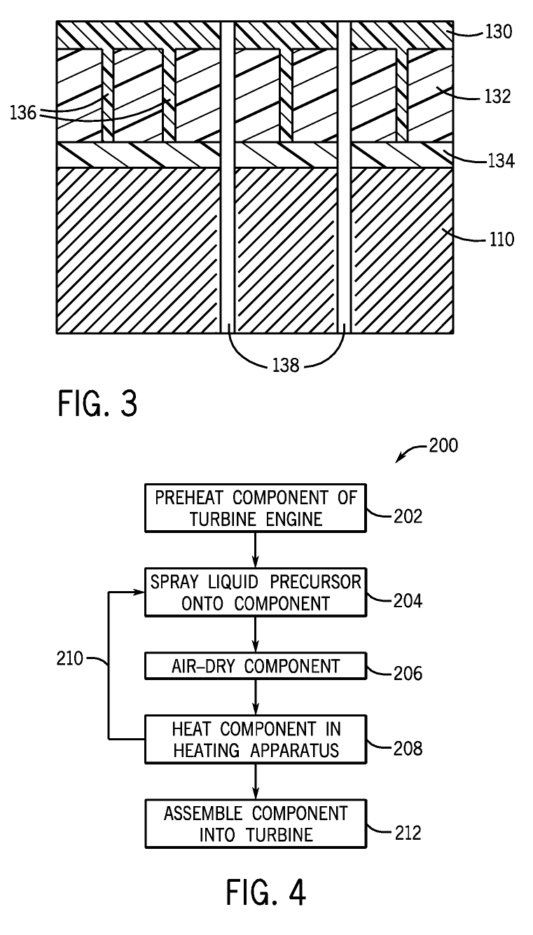

FIG. 2 illustrates an application process 100 of a liquid precursor for a CMAS-resistant coating in accordance with an embodiment of the present invention. As depicted in FIG. 3, a spraying operation 102 may include a spray gun 104 generally having a container 106 and a trigger 108. In other embodiments, other devices suitable for spraying, atomizing, misting, painting, or otherwise distributing a liquid may be used, such as an atomizer or an air gun. The spray gun 104 may be used with a component 110 of a turbine engine, such as a nozzle 32, walls of the combustors 30, turbine blade, or any other component. The illustrated spraying operation 102 may be suitable for components of the turbine engine that are too large to be processed by conventional CMAS-resistant coating deposition processes.

The spraying operation 102 may be performed on the component 110 before assembly into the turbine engine 22. Alternatively, the component 110 may be removed from the assembled turbine engine 22 and subjected to the spraying operation 102. In this manner, the technique described may be applied to existing turbine engines as well as integrated as a manufacture step during assembly of a turbine engine 22.

The container 110 contains a compound 112 for forming the CMAS-resistant coating. In an embodiment, the compound 112 may be referred as a liquid precursor 112. As described below, the CMAS-resistant coating forms when the liquid precursor 112 reacts with oxygen, such as is present in air, to form an oxide. Thus, the liquid precursor 112 may be any compound capable of forming an oxide suitably resistant to CMAS formation and adhereable to the TBC. In some embodiments, the liquid precursor may be any suitable metal-organic compound that contains aluminum, such as long chain aluminum alkoxides, aluminum carboxylates, aluminum beta-diketonates, and aluminum alkyl. In the embodiment described herein, the liquid precursor is aluminum sec-butoxide.

The container 106 may include a pressurized gas 114, to pressurize the contents of the container 108 and act as a carrier for the liquid precursor 112. The gas 114 may be an inert gas, such as nitrogen, argon, etc. The inert gas 114 helps to prevent premature hydrolyzation of the liquid precursor 112 before the precursor 112 is sprayed on the component 110, and acts as a carrier for the liquid precursor 112 as the precursor 112 is not exposed to air before contact with the component 110. Additionally, the pressure of the gas 114 aids in propelling the liquid precursor 112 to the component. In some embodiments, the gas 114 may be added to the applicator directly during addition of the liquid precursor 112. In other embodiments, the gas 114 may be supplied continuously via a connection to a gas canister or other source of the gas 114.

A worker may apply the precursor 112 onto the component 110 by depressing the trigger 108 or otherwise activating the spray gun 104, thereby propelling the liquid precursor 112 into contact with the component 110. Automation equipment, such as a robot, CNC machinery, or other forms of automation, may be used to apply a more uniform layer of precursor onto component 110. In some embodiments, the component 110 may be preheated above ambient temperatures (e.g., from about 500° F. to about 1500° F.) before application of the liquid precursor 112. In other embodiments, the component 110 may not be heated and the spraying operation 100 may be performed at room temperature.

After application of the precursor 112, the component 110 may undergo a drying process 116. The component 110 may be dried in air to allow hydrolysis of the precursor 112. During hydrolysis, the precursor may be converted into an aluminum oxide layer, i.e., the CMAS-resistant coating, on the surface of the TBC of the component 110.

After formation of the oxide, the component 110 may undergo a heating/drying process 118. The component 110 may be placed in an air heat furnace 120, an oven, or other suitable heating device, and the component 110 may be heated to remove moisture or any remaining liquid precursor. In one embodiment, the heating/drying process 120 occurs at about elevated temperatures between about 500° F. to about 2000° F. for a period of time greater than 30 minutes. The application process 100 may be repeated multiple times to build-up the thickness of the CMAS-resistant coating, performing each of the processes 102, 116, and 118 in each iteration. In one embodiment, the process 100 may be repeated 2, 3, 4, or any number times to create the CMAS-resistant coating. In one embodiment, performing the process 3-4 times may result in a CMAS-resistant coating about 3 micrometers thick.

In contrast to application of a coating via CVD or dipping, the spray coating allows specific targeting of areas of the component 110. The spray coating may be applied to minimize or eliminate coating in holes, recesses, cavities, or other topographical features of the component 110. However, application of the spray coating may fully penetrate pores of the thermal barrier coating while avoiding build-up in the features of the component 110. Physical masking of the component 110 to minimize coating in certain areas, such as with tape, may be used. Further, the spray application process 100 may be used on larger components that are unable to be placed in the equipment necessary for CVD or dipping application processes. Additionally, the spray application process 100 may be less costly and time-consuming than the CVD or dipping application processes.

FIG. 3 depicts a cross-section of the component 110 after deposition of a CMAS-resistant coating 130. As described above, the CMAS-resistant coating 130 is a spray coating and not a CVD coating or dip coating. As described above, the component 110 may include a TBC 132 to protect the component from the heat of combustion. The TBC 132 may be disposed on the component 110 via a bonding coating 134. The TBC 132 may be a ceramic coating having a plurality of pores 136. In one embodiment, the TBC 132 may be yttria-stabilized zirconia. In other embodiments, the TBC may be any nonstabilized zirconia, or a partially or fully stabilized zirconia. After undergoing the application process 100 described above, the CMAS-resistant coating 130, e.g., an aluminum oxide, forms on the TBC 132. Further, application of the CMAS-resistant coating 132 via the application process 100 described above also results in formation of the CMAS-resistant coating 130 into the pores 136 of the TBC 132. By forming the CMAS-resistant coating 130 into the pores 136 of the TBC 132, the TBC 132 may be further resistant to CMAS build-up and more resistant to degradation.

The component 110 may also include air holes 138 or other surface features (e.g., recesses, cavities, etc.) to aid in cooling the surface of the component 110. Advantageously, deposition of the CMAS-resistant coating 130 via the application process 100 also results in less build-up of the coating 130 in the air holes 138 as compared to conventional methods such as dipping.

FIG. 4 depicts a process 200 for application of the CMAS-resistant coating 130 in accordance with an embodiment of the present invention. A component for the turbine engine 12 may be preheated to above ambient temperature (e.g., such as between about 500° F. and about 1500° F.) before application of the CMAS-resistant coating (block 202). A liquid precursor that forms the CMAS-resistant coating may be sprayed, atomized, misted, painted, or otherwise applied to a component via a sprayer or atomizer (block 204). In contrast, a CVD application process may require costly chemicals and reaction chambers to enable application of a coating, and a component must be fully enclosed in the reaction chambers. As described above, the liquid precursor may be stored with a carrier gas in the sprayer or atomizer to help prevent premature hydrolyzation. The carrier gas may also act as a carrier as the liquid precursor is in the air before contact with the component. In some embodiments, the application process may be performed via a handheld applicator operable by a technician. In other embodiments, the applicator may be an industrial-type sprayer or atomizer operable via an industrial automation system such as a robot or CNC machine, such that the application of the liquid precursor may be performed automatically on an industrial scale.

After application of the liquid precursor, the component may be air-dried such that the precursor reacts with air to form an oxide coating on the component (block 206). The component may then be placed into an oven or other heating apparatus to remove any unreacted liquid precursor or other substances on the component (block 208). As illustrated by arrow 210, the application may be repeated by re-initiating the spraying or atomizing process (block 204). Finally, after formation of the CMAS-resistant coating (e.g., one, two, three, four, or more layers), the component may be assembled into a turbine engine (block 212).

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method of manufacturing, comprising:
applying a liquid compound to a component of a turbine engine, such that the compound is disposed on a thermal barrier coating of the component; and
forming an oxide layer with the liquid compound on the thermal barrier coating of the component.

2. The method of claim 1, wherein the liquid component is applied via a pressurized gas.

3. The method of claim 1, wherein forming the oxide layer comprises exposing the component to air after applying the liquid compound to the component.

4. The method of claim 1, comprising heating the component such that the component is at an elevated temperature while applying the liquid compound.

5. The method of claim 1, comprising heating the component such that the component is at an elevated temperature after applying the liquid compound to aid with forming the oxide layer and drying the liquid compound.

6. The method of claim 1, comprising heating the component to between about 500° F. and 2000° F.

7. The method of claim 1, comprising repeating steps of applying and forming to create multiple layers of oxide via the liquid component.

8. The method of claim 1, wherein the compound consists essentially of one of an aluminum alkoxide, aluminum carboxylate, aluminum beta-diketonate, aluminum alkyl, or any combination thereof.

9. The method of claim 1, wherein the compound comprises aluminum sec-butoxide.

10. The method of claim 2, wherein the pressurized gas comprises one of nitrogen, argon, other inert gas, or a combination thereof.

11. The method of claim 2, wherein the pressurized gas acts as a carrier of the compound to the component via spraying, atomizing, misting, or painting.

12. The method of claim 1, wherein applying the liquid compound comprises spraying, atomizing, misting, or painting the liquid compound.

13. The method of claim 1, comprising heating the component for greater than 30 minutes after applying the liquid compound.

14. A manufacturing system, comprising:
a sprayer containing a liquid compound and an inert gas, wherein the sprayer is configured to apply the liquid compound to a thermal barrier coating of a turbine engine component, such that the liquid compound forms an oxide on the thermal barrier coating.

15. The manufacturing system of claim 14, wherein the sprayer comprises a spray gun, an air gun, an atomizer, or a combination thereof.

16. The manufacturing system of claim 14, wherein the compound consists essentially of one of an aluminum alkoxide, aluminum carboxylate, aluminum beta-diketonate, aluminum alkyl, or any combination thereof.

17. The method of claim 14, wherein the compound comprises aluminum sec-butoxide.

18. The manufacturing system of claim 14, wherein the inert gas comprises one of nitrogen, argon, or any combination thereof.

19. A system, comprising:
a thermal barrier coating comprising yttria-stabilized zirconia; and
a protective coating comprising aluminum oxide disposed on the thermal barrier coating, wherein the protective coating is a spray coating that oxidized in air.

20. The system of claim 19, comprising a turbine component, wherein the thermal barrier coating is disposed on the engine component.
